(19) United States
(12) Patent Application Publication
(10) Pub. No.: US 2026/0228513 A1
(43) Pub. Date: Aug. 6, 2026

(54) HYBRID SPECULATIVE DECODING IN MACHINE LEARNING MODELS

(71) Applicant: QUALCOMM Incorporated, San Diego, CA (US)

(72) Inventors: Tien Viet NGUYEN, Bridgewater, NJ (US); June NAMGOONG, San Diego, CA (US); Junyi LI, Greentown, PA (US); Kapil GULATI, Belle Mead, NJ (US); Gene Wesley MARSH, San Diego, CA (US); Shailesh PATIL, San Diego, CA (US)

(21) Appl. No.: 19/046,292

(22) Filed: Feb. 5, 2025

(51) Int. Cl. G06N 3/0495

(52) U.S. Cl. CPC G06N 3/0495

(57) ABSTRACT

Certain aspects of the present disclosure provide techniques and apparatus for machine learning. In an example method, a set of tokens is generated using a secondary generative machine learning model associated with a primary generative machine learning model, and a subset of tokens is selected, from the set of tokens, for verification by the primary generative machine learning model. The subset of tokens is sent to the primary generative machine learning model for verification, and a machine learning model output comprising one or more verified tokens from the subset of tokens and one or more remaining tokens from the set of tokens is generated.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), and/or large multimodal models (LMMs) to process and generate output data. Often, machine learning models (especially LLMs, LVMs, and LMMs) have many parameters (e.g., millions or even billions), resulting in significant model size, as well as substantial computational expense and time to generate output using the model.

Some recent efforts to mitigate the computational expense of such generative models include speculative decoding, where a less computationally expensive model (referred to in some aspects as a “draft model”) can be used to generate a subset of the tokens in the output (rather than using the larger model, often referred to as the “target model,” for all tokens).

### BRIEF SUMMARY

Certain aspects of the present disclosure provide a processor-implemented method, comprising: generating, using a secondary generative machine learning model associated with a primary generative machine learning model, a first set of tokens; selecting a first subset of tokens, from the first set of tokens, for verification by the primary generative machine learning model; sending the first subset of tokens to the primary generative machine learning model for verification; and generating a machine learning model output comprising one or more verified tokens from the first subset of tokens and one or more remaining tokens from the first set of tokens.

Certain aspects of the present disclosure provide a processor-implemented method, comprising: receiving, at a primary generative machine learning model, a first set of tokens generated using a secondary generative machine learning model associated with the primary generative machine learning model; identifying a first subset of tokens, from the first set of tokens, marked for verification; processing the first set of tokens using a first subset of layers, of a plurality of layers of the primary generative machine learning model, to generate a first set of hidden tensors; selecting a first subset of the first set of hidden tensors corresponding to the first subset of tokens; processing the first subset of hidden tensors using a second subset of layers, of the plurality of layers, to generate a set of target logits for the first subset of tokens; and verifying one or more of the first subset of tokens based on the set of target logits.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for hybrid speculative decoding, according to some aspects of the present disclosure.

FIG. 2 depicts an example workflow for generating and qualifying draft tokens using a secondary machine learning model, according to some aspects of the present disclosure.

FIG. 3 depicts an example workflow for verifying draft tokens using a primary machine learning model, according to some aspects of the present disclosure.

FIG. 4 is a flow diagram depicting an example method for generating and qualifying draft tokens using a secondary machine learning model, according to some aspects of the present disclosure.

FIG. 5 is a flow diagram depicting an example method for verifying draft tokens using a primary machine learning model, according to some aspects of the present disclosure.

FIG. 6 is a flow diagram depicting an example method for generating machine learning model output using a secondary generative model, according to some aspects of the present disclosure.

FIG. 7 is a flow diagram depicting an example method for verifying machine learning model output using a primary generative model, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, more effective and efficient speculative decoding is provided.

Many model architectures, such as transformer-based models (e.g., LLMs) and diffusion models (e.g., LVMs) have shown great promise in generating useful output data. However such generative models are often slow at inference time (e.g., taking substantial time to generate output tokens, where each token generally corresponds to a portion of the model output, such as a single character or word, a portion of word, a pixel or other portion of an image, and the like). Such architectures are similarly computationally expensive (e.g., consuming substantial memory, as well as processor time and energy, and resulting in substantial heat generation). As a result, a variety of techniques have been developed to accelerate the token generation rate and/or reduce the computational expense of the token generation. One such technique includes speculative decoding, where a drafting phase is performed to produce “draft” tokens using a relatively less expensive and/or quicker draft model (referred to in some aspects as a “secondary” model). These draft tokens can then undergo a verification phase to determine whether the draft tokens are “accepted” or “rejected” (e.g., by the slower and/or more computationally expensive target model, referred to in some aspects as a “primary” model) to produce the final set of output tokens.

Although the secondary model generally generates output tokens sequentially (e.g., one at a time), but the primary model can often evaluate (e.g., for verification purposes) some or all of the draft tokens in parallel. Although this parallelism can reduce generation latency, some conventional approaches to speculative decoding do not actually decrease computational expense at all. That is, the primary model still generally verifies all draft tokens, which involves processing all of the draft tokens through all of the primary model, incurring substantial expense. Some aspects of the present disclosure provide hybrid speculative decoding where the primary model may be used to selectively verify a subset of the tokens and/or where some or all of the draft tokens may be processed using only a subset of the primary model to perform token verification. These approaches can substantially reduce the computational expense of the generation process.

In some aspects, as used herein, a “primary” model (also referred to as a “primary generative model” or a “primary generative machine learning model”) may generally refer to a generative machine learning model from which output generated data is desired. For example, the primary model may correspond to an LLM being used to generate outputs. In some aspects, the primary model may incur fairly substantial latency and/or computational expense to generate output tokens (e.g., due to the size of the model). Similarly, as used herein, a “secondary model” (also referred to as a “secondary generative model” or a “secondary generative machine learning model”) may generally refer to a smaller and/or less complex generative machine learning model that can be used as a surrogate for the primary model in some cases (e.g., generating similar output, potentially with somewhat reduced accuracy or quality). Generally, the secondary model may incur less latency and/or computational expense to generate output tokens, as compared to the primary model, such as due to the relatively smaller size and/or lower complexity of the secondary model. In some aspects, the primary and secondary models may be referred to as the “target” and “draft” models, respectively.

In some aspects of the present disclosure, a secondary model may be used to generate a set of draft tokens. The secondary model (or another component) may identify and mark a subset of the generated tokens for verification by the primary model. For example, if the secondary model generates k tokens during a given drafting phase, the model may mark m<k tokens for verification. In some aspects, the remaining tokens are not verified by the primary model, which can substantially reduce computational expense of the speculative decoding process.

In some aspects, the generated set of draft tokens, along with the generated logits for the marked m tokens to be verified, can be provided for analysis using a primary model. In some aspects, the secondary model and the primary model may be implemented or executed on different computing systems (e.g., where the secondary model executes on a local system, such as a user's smartphone, and the primary model executes on a remote system, such as in the cloud). In some aspects, the secondary and primary models may be implemented on a single computing system using different processing units (e.g., where a central processing unit (CPU) is used to execute the secondary model, and an accelerator such as a graphics processing unit (GPU) or neural processing unit (NPU) is used to execute the primary model). In some aspects, the secondary and primary models may be implemented using a single processing unit, where the parameters of the primary model may be stored in a relatively lower speed memory, as compared to the parameters of the secondary model.

In some aspects, the primary model can then process the set of draft tokens (in parallel) through a first subset or portion of the primary model (e.g., one or more self-attention layers). In some aspects, after this first portion of the primary model, the system may continue to process only the marked tokens (e.g., those marked for verification) using the remaining portion(s) or layer(s) of the primary model (e.g., one or more cross-attention layers). In some aspects, the hidden tensor(s) generated using the first portion of the primary model (for non-marked tokens) may be used to facilitate verification of the marked tensors using the remaining portions of the model (e.g., to enable cross-attention). By only processing some of the tokens (e.g., the non-marked tokens) through a subset of the primary model, computational expense of the verification process can be reduced.

### Example Workflow for Hybrid Speculative Decoding

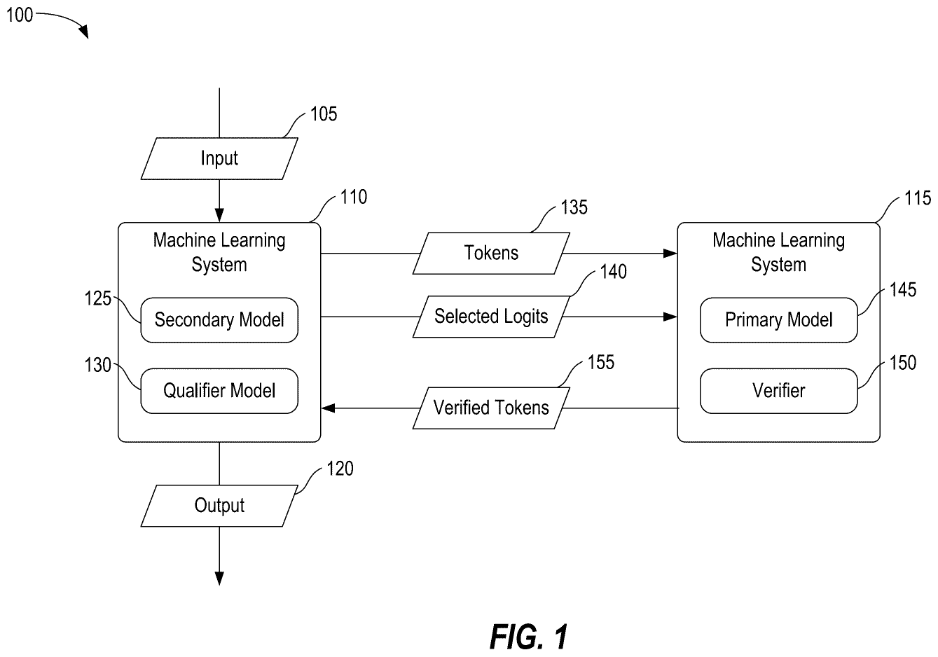

FIG. 1 depicts an example workflow 100 for hybrid speculative decoding, according to some aspects of the present disclosure.

In the workflow 100, a machine learning system 110 hosting a secondary model 125 is communicatively coupled with a machine learning system 115 hosting a primary model 145. Although depicted as discrete systems for conceptual clarity, in some aspects, the machine learning systems 115 may correspond to or be implemented by a single system. For example, as discussed above, the machine learning system 110 may correspond to or be implemented by a first processing domain or unit (e.g., a CPU) while the machine learning system 115 may correspond to or be implemented by a second processing domain or unit (e.g., a GPU) of the same physical computing system.

In other aspects, the machine learning system 110 and machine learning system 115 may be implemented using discrete systems (which may or may not be collocated). For example, in some aspects, the machine learning system 110 may correspond to a relatively compute-constrained device (e.g., an edge device such as a smartphone, laptop computer, and the like) while the machine learning system 115 may correspond to a relatively less constrained device (e.g., a server).

In the illustrated workflow 100, the machine learning system 110 accesses inputs 105 to be processed using machine learning in order to generate outputs 120. As used herein, “accessing” data may generally include receiving, requesting, retrieving, generating, obtaining, or otherwise gaining access to the data. For example, the machine learning system 110 may receive the input 105 from a user, or from another device or system (not depicted). The particular format and content of the input 105 may vary depending on the particular implementation. For example, in some aspects, the input 105 may be a textual phrase or other input conditioning used to guide or control the generative machine learning (e.g., a phrase describing an image that is desired, where the machine learning model(s) comprise generative text-to-image models). Although the illustrated example depicts a single input 105, the machine learning system 110 may use multiple inputs or no inputs, depending on the particular implementation.

As illustrated, the machine learning system 110 includes a secondary model 125 (e.g., a secondary generative machine learning model, as discussed above) and a qualifier model 130 (referred to in some aspects as a qualifier machine learning model). Although depicted as a discrete model for conceptual clarity, in some aspects, the qualifier model 130 may be implemented as part of the secondary model 125 (e.g., as a new output layer, such as a linear layer). For example, the secondary model 125 may include a sequence of attention-based layers to generate and transform a hidden state or tensor, which may then be processed using a linear layer to generate a set of logits. These logits can then be processed (e.g., using a softmax operation) to generate a set of normalized probabilities, and these probabilities can then be sampled to select a token as output of the secondary model 125. In some aspects, the qualifier model 130 may similarly be implemented as a linear model that uses, as input, the final hidden state of the secondary model 125, the logits generated by the secondary model 125, and/or the generated output token. For example, in some aspects, the qualifier model 130 may take the hidden state output of the final layer of the secondary model 125 as input to qualify the tokens (e.g., to determine which tokens should be verified). As another example, in some aspects, the qualifier model 130 may take the hidden state output of the final layer of the secondary model 125, as well as the generated tokens and/or logits from the secondary model 125, as input to qualify the tokens.

While the linear layer of the secondary model 125 seeks to generate logits representing the (non-normalized) probability that each of a set of possible output tokens should be selected as the “next” token in the model output 120, the qualifier model 130 may seek to generate scores indicating whether the output of the secondary model 125 (e.g., the generated token) should be verified by the primary model 145 or should be accepted without verification.

In some aspects, during a given drafting phase, the secondary model 125 may generate one or more draft tokens (e.g., sequentially). Each generated token may similarly be evaluated using the qualifier model 130 to generate a score indicating whether the token should be marked for verification. In some aspects, the machine learning system 110 may generate a fixed number of draft tokens (e.g., a predefined number) and may then select a fixed or variable number of these tokens for verification (e.g., selecting the m tokens scored highest by the qualifier model 130, or selecting any tokens having a score higher than a threshold). That is, the system may iteratively generate tokens until the set of draft tokens contains a defined (e.g., target) maximum number of draft tokens. In some aspects, the machine learning system 110 may generate a dynamic number of draft tokens. For example, the machine learning system 110 may generate a draft token, and determine whether to verify the draft token based on comparing the corresponding score (generated by the qualifier model 130) to a threshold. In some aspects, the machine learning system 110 may continue generating draft tokens until a defined number of such tokens have been selected for verification. That is, the system may iteratively generate and qualify tokens until the subset of to-be-verified tokens contains a defined (e.g., target) number of tokens for verification.

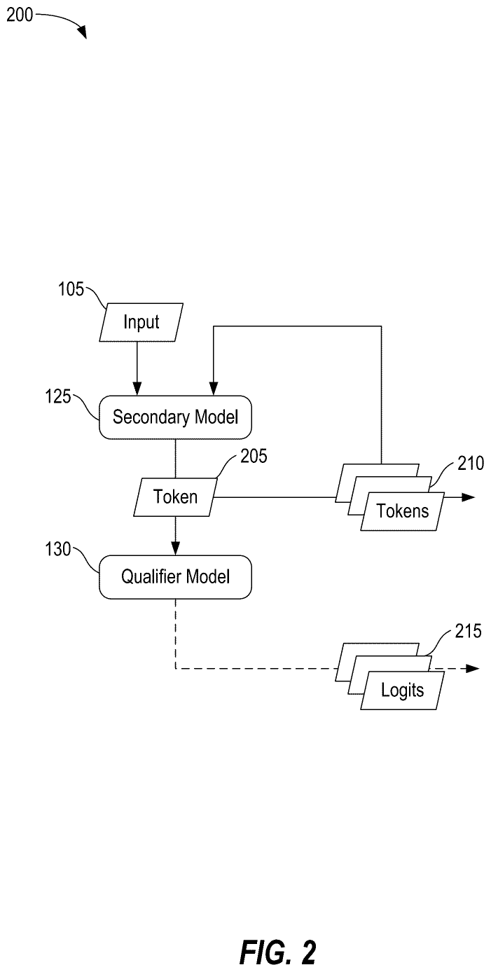

In the illustrated workflow 100, the machine learning system 110 transmits the generated set of tokens 135 (generating during the drafting phase), as well as a set of selected logits 140, to the machine learning system 115. Generally, the tokens 135 comprise the entire set of tokens that the secondary model 125 generated during the drafting phase (whether marked for verification or not). The selected logits 140 may correspond to those tokens that were selected for verification. For example, suppose the tokens 135 includes k tokens, and the machine learning system 110 determined to verify a subset of m tokens (e.g., the first token in the sequence of tokens 135, third token, seventh token, and so on). In the illustrated example, the selected logits 140 may correspond to the logits used to generate the selected or marked tokens (e.g., the logits that were generated by the secondary model 125 and processed to generate the first token, the third token, the seventh token, and so on). In some aspects, the machine learning system 110 may refrain from transmitting or providing the logits (or other data) for the non-selected tokens (e.g., the subset of the tokens 135 that were not selected for verification). That is, in some aspects, only the logits for the selected tokens are provided, which may reduce bandwidth and transmission latency. Some example techniques for generating the tokens 135 and selected logits 140 are discussed in more detail below with reference to FIGS. 2 and/or 4.

Although not included in the illustrated example, in some aspects, the selected logits 140 (e.g., the tokens to be verified) may be selected by the machine learning system 15 using the primary model 145, as discussed in more detail below.

As illustrated, the machine learning system 115 includes a primary model 145 (e.g., a primary generative machine learning model, as discussed above) and a verifier 150. In the illustrated workflow 100, the machine learning system 115 can process some or all of the tokens 135 using some or all portions of the primary model 145 to perform token verification (e.g., to accept or reject the token(s)). In some conventional systems, the primary model 145 processes all of the tokens 135 simultaneously (e.g., in parallel) to verify (or reject) each token. However, as discussed above, this parallelism improves verification latency but does not reduce computational expense of the verification.

In the illustrated workflow 100, the machine learning system 115 may identify the marked subset of tokens, from the overall set of tokens 135, that were flagged or otherwise indicated for verification (e.g., by the qualifier model 130). In some aspects, as discussed in more detail below, the machine learning system 115 may process all of the tokens 135 using at least a first portion of the primary model 145. For example, in some aspects, the primary model 145 may be broadly delineated into a self-attention phase (where each token undergoes one or more self-attention operations) and a cross-attention phase (where each token undergoes one or more cross-attention operations with respect to each other token in the set of tokens 135).

In some aspects, if the primary model 145 is used to mark or identify the tokens for verification, the qualifier model 130 may receive the output hidden tensors from the first portion of the primary model 145 (e.g., from the final self-attention layer) to select which token(s) should be verified.

In some aspects, therefore, the machine learning system 115 may process all of the tokens 135 using the first portion of the primary model 145 (e.g., through the self-attention layer(s)) to generate a set of hidden tensors (one for each token 135). The machine learning system 115 may then continue processing a subset of these hidden tensors (e.g., the hidden tensors corresponding to tokens that were marked for verification, either by the machine learning system 110 or the machine learning system 115) using the remaining portion(s) of the primary model 145 (e.g., through the cross-attention layer(s)). In some aspects, as discussed in more detail below, the hidden tensor(s) for the non-marked token(s) (generated using the first portion of the primary model 145) may be used to facilitate the subsequent processing of the selected tokens (using the subsequent portion of the primary model 145).

In some aspects, the primary model 145 generates, for each token marked for verification (e.g., from the set of tokens 135), a set of logits. As discussed above, the logits generally represent a non-normalized (e.g., relative log-likelihood) probability distribution, where each value of a set of logits indicates the probability that the corresponding token should be selected as the output token. For example, during ordinary generation, the logits may be processed (e.g., by a softmax layer) to normalize the probabilities (e.g., such that the probabilities sum to a value of one), and the primary model 145 may then probabilistically sample or select the output token using these probabilities.

In the illustrated workflow 100, the logits generated by the primary model 145 may instead be compared against the selected logits 140 (e.g., by the verifier 150). For example, the verifier 150 may compare the set of logits (referred to in some aspects as target logits) generated by the primary model 145 for a given token (of the set of tokens 135) against the corresponding set of logits from the selected logits 140. In some aspects, if the logits are sufficiently similar, the verifier 150 may “verify” the corresponding token (e.g., the token is said to be accepted or verified by the primary model 145, because the logits generated by the secondary model 125 are sufficiently similar to the logits generated by the primary model 145). If the logits are not sufficiently similar, the verifier 150 may reject the corresponding token. In some aspects, if a token (of the set of tokens 135) is rejected, the corresponding target logits (generated by the primary model 145) may be processed to select or generate a new token (referred to in some aspects as an “alternative” token) to be used in place of the rejected token.

In the illustrated example, the machine learning system 115 may transmit a set of verified tokens 155 to the machine learning system 110. In some aspects, the verified tokens 155 correspond to any tokens that were verified (e.g., by the verified 150). For example, the machine learning system 115 may only transmit tokens that were evaluated and verified (e.g., refraining from transmitting tokens, from the set of tokens 135 that were not evaluated and/or were rejected). In some aspects, the verified tokens 155 may include all accepted tokens (e.g., the tokens, from the set of tokens 135, that were not evaluated (e.g., because these tokens were not marked for verification), as well as the tokens that were evaluated and verified). In some aspects, the verified tokens 155 includes all of the tokens 135, with labels indicating whether each is accepted (e.g., not evaluated by the primary model 145), verified (e.g., evaluated and verified by the primary model 145) or rejected (e.g., evaluated and rejected by the primary model 145).

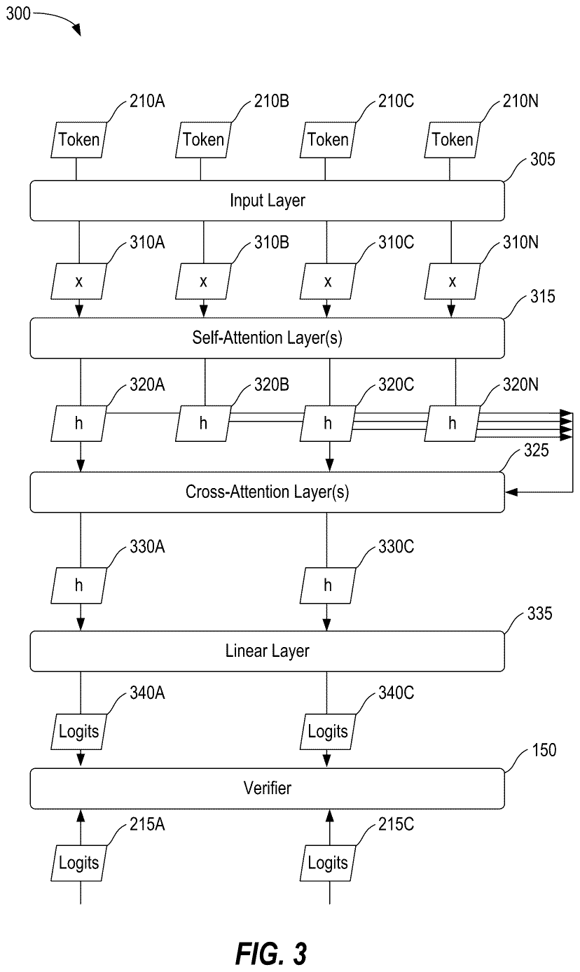

In some aspects, the verified tokens 155 may include alternative token(s) for any rejected tokens. For example, a discussed above, the machine learning system 115 may generate a proposed alternative token for a rejected token based on processing the corresponding target logits. In some aspects, these alternative tokens may be included in the verified tokens 155 for inclusion in the model output 120. Some example techniques for verifying the tokens 135 are discussed in more detail below with reference to FIGS. 3 and/or 5.

In the illustrated workflow 100, the machine learning system 110 may add (e.g., by concatenation) the verified tokens 155 to the model output 120. In some aspects, the machine learning system 110 may then either begin a new drafting phase (e.g., if the drafting termination criteria are not met), or may terminate drafting and provide the output 120 as the output of the machine learning model.

### Example Workflow for Generating and Qualifying Draft Tokens Using a Secondary Machine Learning Model

FIG. 2 depicts an example workflow 200 for generating and qualifying draft tokens using a secondary machine learning model, according to some aspects of the present disclosure. In some aspects, the workflow 100 provides additional detail for the operations of a machine learning system, such as the machine learning system 110 of FIG. 1.

In the illustrated workflow 200, input 105 (e.g., textual conditioning as discussed above) is provided to the secondary model 125 to generate an output token 205 (e.g., a draft token). In the illustrated example, this token 205 is added to a set of draft tokens 210 that have been generated during the current drafting phase. As illustrated, to generate the next token, the set of current draft tokens 210 are also provided as contextual input to the secondary model 125. For example, given the current sequence of tokens 210 and the input 105, the secondary model 125 may be tasked with predicting what token 205 should come next in the sequence.

In the illustrated example, each token 205 is also processed using the qualifier model 130. Although the illustrated example depicts processing the token 205 itself using the qualifier model 130, in some aspects, the qualifier model 130 may additionally or alternatively process other data. For example, in some aspects, the qualifier model 130 may process the logits used to generate the token 205, the hidden tensor(s) used to generate the token 205, and the like. In some aspects, the qualifier model 130 may be implemented as a lightweight model (e.g., a single linear layer, one or more multilayer perceptrons (MLPs), one or more transformer layers, and the like).

As illustrated based on the output of the qualifier model 130, the machine learning system may determine whether to mark the token 205 for verification. If not (e.g., if the score is below a threshold), the token 205 may be added to the set of draft tokens 210 without any flag (e.g., without flagging the token for verification). If the score satisfies the threshold (or the qualifier model 130 otherwise determines that the token 205 should be verified), the token 205 may nevertheless be added to the set of tokens 210 (e.g., with a flag or label indicating that the token should be verified). In the illustrated example, if a given token is selected for verification, the machine learning system may add the corresponding logits (generated by the secondary model 125 and used to generate or select the sampled token 205) to a set of selected logits 215.

As illustrated, after the drafting phase completes, the tokens 210 (which may correspond to the tokens 135 of FIG. 1) and the logits 215 (which may correspond to the selected logits 140 of FIG. 1) are provided (e.g., to the machine learning system 115 of FIG. 1) for selective verification.

Although not depicted in the illustrated example, in some aspects, the machine learning system may also receive verified and/or approved tokens (which may include alternative tokens), as discussed above. In such an aspect, the machine learning system may update the currently pending output using the verified tokens, and may output or provide the model output once drafting is over.

### Example Workflow for Verifying Draft Tokens Using a Primary Machine Learning Model

FIG. 3 depicts an example workflow 300 for verifying draft tokens using a primary machine learning model, according to some aspects of the present disclosure. In some aspects, the workflow 200 provides additional detail for the operations of a machine learning system, such as the machine learning system 115 of FIG. 1.

In the illustrated workflow 300, a set of tokens 210A-N (e.g., corresponding to the tokens 135 of FIG. 1) are accessed for evaluation and/or verification using a primary machine learning model (e.g., the primary model 145 of FIG. 1) based at least in part on a corresponding set of logits 215A-C (e.g., the selected logits 140 of FIG. 1). In the illustrated example, the primary model includes a set of components including an input layer 305, a set of one or more self-attention layers 315, a set of one or more cross-attention layers 325, and a linear layer 335. In some aspects, the linear layer 335 may be referred to as the “language model head.” In some aspects, each of the one or more self-attention layers 315 may correspond to a transformer layer that implements self-attention (e.g., including the self-attention operation, as well as a MLP interleaved by normalization and skip connection(s)). Similarly, in some aspects, each of the one or more cross-attention layers 325 may correspond to a transformer layer that implements cross-attention (e.g., including the cross-attention operation, as well as a MLP interleaved by normalization and skip connection(s)).

In the illustrated example, the tokens 210A-N were generated using a secondary model, and at least a subset of the tokens 210 are processed by the primary model to perform verification. Specifically, in the illustrated example, the token 210A and the token 210C are being verified (e.g., the tokens 210A and 210C were marked for verification by the qualifier model), while the tokens 210B and 210N are not undergoing verification. As illustrated, the input layer 305 of the primary model is generally used to generate a tensor representation (e.g., a feature tensor) for each token 210. Specifically, the feature tensor 310A is generated based on the token 210A, the feature tensor 310B is generated based on the token 210B, the feature tensor 310C is generated based on the token 210C, and the feature tensor 310N is generated based on the token 210N.

In the illustrated architecture, the feature tensors 310 are then processed using one or more self-attention layers 315 of the primary model. For example, the self-attention layer(s) 315 may include one or more transformer blocks where the queries, keys, and values when computing attention for the feature tensor 310A are all defined (using learned weight matrices) based on the feature tensor 310A. These queries, keys, and values are then aggregated to generate the hidden tensor for the token 210A.

As illustrated, the output of the one or more self-attention layers 315 is a set of hidden tensors 320A-N (also referred to in some aspects as hidden states), one for each input token 210. Specifically, Specifically, the hidden tensor 320A is generated based on the feature tensor 310A for the token 210A, the hidden tensor 320B is generated based on the feature tensor 310B for the token 210B, the hidden tensor 320C is generated based on the feature tensor 310C for the token 210C, and the hidden tensor 320N is generated based on the feature tensor 310N for the token 210N.

In some conventional approaches, as discussed above, each of these hidden tensors 320 then undergoes continued processing using the remaining model layers (e.g., the cross-attention layers 325). In some aspects, though batching may be used to increase parallelizability, batching cross-attention operations can incur substantial memory consumption.

In some aspects, if the primary model is used to perform token qualification (rather than the secondary model), the hidden tensors 320A-N output by the final self-attention layer 315 may be used as input to the qualified model. The qualifier model may then select which token(s) should be verified (e.g., which should be processed using the remaining layers of the primary model to perform token verification).

In the illustrated example, therefore, only a subset of the hidden tensors 320 undergoes processing using the cross-attention layers 325. Specifically, as discussed above, if the tokens 210A and 210C were selected for verification (using either the primary or the secondary model), the machine learning system may process the corresponding hidden tensors 320A and 320C using the cross-attention layers 325, refraining from further processing of the hidden tensors 320B and 320N. In some aspects, the hidden tensors 320B and 320N may still be used to compute some of the keys and values of the cross-attention layers 325

For example, with respect to a given token, the queries of a given cross-attention layer 325 may be defined based on the corresponding hidden tensor used as input to the cross-attention layer 325, and a learned set of query weights. In some aspects, the keys and/or values may be defined based on the hidden tensors 320 (output by the self-attention layers 315), rather than directly based on the input to the cross-attention layer 325. For example, suppose the hidden tensor 320A is defined as

$${h}_{A}^{i}$$

to indicate that this tensor is generated by the i-th layer of the model (e.g., the final self-attention layer 315) for the token 210A. Suppose further that the L-th layer (e.g., one of the cross-attention layers 325) is processing this token. In some aspects, the queries for the L-th layer be defined based on a first weight tensor and

$${h}_{A}^{L - 1}$$

(e.g., the hidden tensor generated for the input token 210A by the prior layer L−1), while the keys and values for this layer may be defined based on second and third weight tensors and

$${h}_{A}^{i} .$$

By using these hidden tensors 320 for subsequent cross-attention, the machine learning system can substantially reduce the computational expense of the verification.

As illustrated, the output of the cross-attention layer(s) 325 is a respective hidden tensor 330 for each token 210 undergoing verification. Specifically, the machine learning system generates a hidden tensor 330A for the token 210A, as well as a hidden tensor 330C and for the token 210C. In the depicted example, these hidden tensors 330 are processed using a linear layer 335 to generate corresponding sets of logits (e.g., the logits 340A for the token 210A and the logits 340C for the token 210C). In some aspects, as discussed above, these logits 340 may be referred to as “target logits” to indicate that these logits were generated by the primary model.

As illustrated, the verifier 150 can then compare each set of target logits 340 with the corresponding logits 215 generated by the secondary model. As discussed above, the verifier 150 may verify or approve the generated token 210 if the corresponding logits 215 are sufficiently similar to the corresponding target logits 340, and may otherwise reject the token. Generally, a wide variety of distance or similarity metrics may be used to compare the logits 340 with the logits 215, depending on the particular implementation.

In some aspects, as discussed above, the target logits 340 may optionally be processed using one or more further components of the primary model (e.g., a softmax operation) to generate token probabilities that can then be directly sampled to generate an alternative token for the corresponding token 210. For example, if the logits 215C are not sufficiently similar to the logits 340C, the machine learning system may process the logits 340C to generate or select a new (alternative) token to replace the token 210C.

In some aspects, the secondary model may use a similar architecture to generate the tokens 210. Further, in some aspects, as discussed above, the qualifier model may be implemented using a relatively lightweight model, such as a trained linear layer, one or more transformer layers, one or more MLPs, and the like (e.g., to replace the linear layer 335), where the qualifier model is trained to generate quality scores for the tokens (e.g., based on the probability that the corresponding token should be approved or verified by the primary model).

Although not depicted in the illustrated example, in some aspects, the machine learning system may then transmit verified and/or approved tokens (which may include alternative tokens), to the initiating system.

### Example Method for Generating and Qualifying Draft Tokens Using a Secondary Machine Learning Model

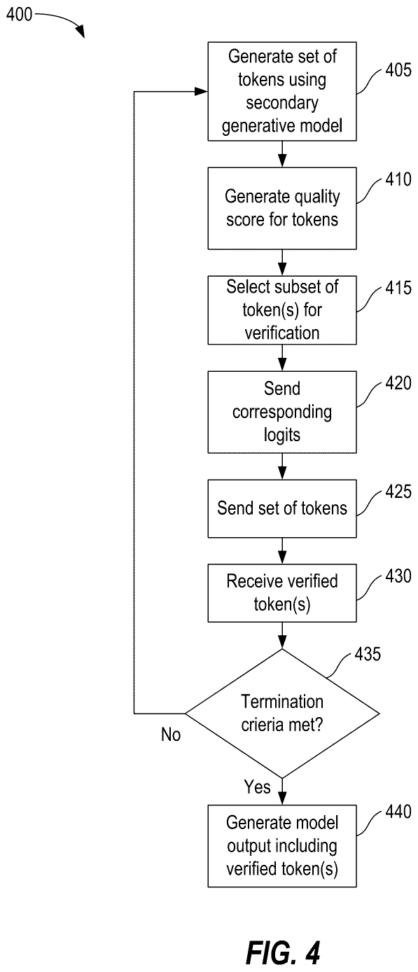

FIG. 4 is a flow diagram depicting an example method 400 for generating and qualifying draft tokens using a secondary machine learning model, according to some aspects of the present disclosure. In some aspects, the method 400 provides additional detail for the operations of a machine learning system, such as the machine learning system 110 of FIG. 1. In some aspects, the method 400 provides additional detail for the workflow 200 of FIG. 2.

At block 405, the machine learning system generates a set of token(s) (e.g., the tokens 135 of FIG. 1 and/or the tokens 210 of FIG. 2) using a secondary generative machine learning model (e.g., the secondary model 125 of FIGS. 1-2).

At block 410, the machine learning system generates a respective quality score for each respective token of the set of token(s) (e.g., using a qualifier model 130 of FIGS. 1-3). For example in some aspects, the machine learning system may process the generated token (or related data, such as the logits or hidden tensors used to generate the token) using one or more other models (e.g., a linear layer) to quantify or predict the quality of the token (e.g., whether the token should be verified by the primary model).

At block 415, the machine learning system selects a subset of tokens, from the total set of tokens generated at block 405, for verification using the primary model. For example, in some aspects, the machine learning system generates a specified number of tokens at block 405, then dynamically selects tokens for verification. As another example, in some aspects, the machine learning system may generate and score tokens individually until a specified number of tokens marked for verification have been generated.

At block 420, the machine learning system sends the corresponding set(s) of logit(s) (e.g., the selected logits 140 of FIG. 1 and/or the logits 215 of FIG. 2) for each to-be-verified token to a verification system (e.g., to the machine learning system 115 of FIG. 1) to be verified.

At block 425, the machine learning system sends the generated set of tokens to the verification system (e.g., the tokens generated at block 405).

At block 430, the machine learning system receives verified token(s) (e.g., the verified tokens 155 of FIG. 1) from the verification system. In some aspects, as discussed above, the verified tokens may include a subset of the total set of tokens generated at block 405 (e.g., only the tokens that were evaluated and verified by the primary model), or may include all tokens (e.g., with a label for each indicating acceptance or rejection). In some aspects, as discussed above, the verified token(s) may include a substitute or alternative token for any rejected tokens.

At block 435, the machine learning system determines whether one or more generation termination criteria are satisfied. The machine learning system may generally use a variety of termination criteria, such as determining whether a defined amount of time or computational resources have been spent generating output, whether the set of verified tokens includes an end or “stop generation” token indicating the end of the output, and the like.

If, at block 435, the machine learning system determines not to terminate generation, the method 400 returns to block 405 to begin another drafting phase. If the machine learning system determines to terminate generation, the method 400 continues to block 440.

At block 440, the machine learning system generates model output (e.g., the output 120 of FIG. 1) including the verified tokens. In some aspects, the machine learning system may generate the output as an ordered sequence of tokens, including (i) tokens generated by the secondary model and not flagged for verification, (ii) tokens generated by the secondary model, marked for verification, and subsequently verified by the primary model, and (iii) alternative tokens provided by the primary model to replace rejected tokens.

As discussed above, this hybrid speculative decoding process can substantially reduce the latency and computational expense of generating the model output, as compared to some conventional approaches.

### Example Method for Verifying Draft Tokens Using a Primary Machine Learning Model

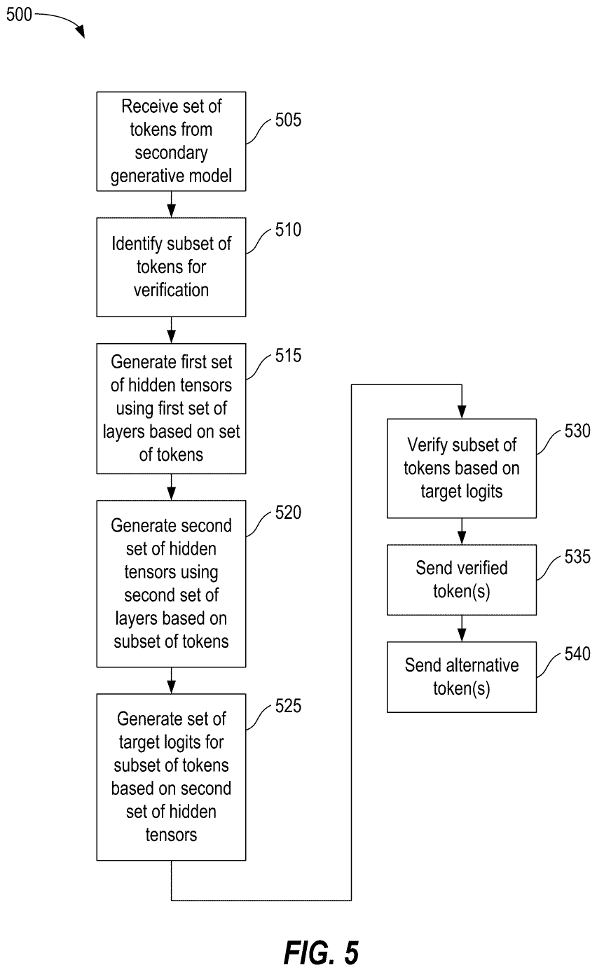

FIG. 5 is a flow diagram depicting an example method 500 for verifying draft tokens using a primary machine learning model, according to some aspects of the present disclosure. In some aspects, the method 500 provides additional detail for the operations of a machine learning system, such as the machine learning system 115 of FIG. 1. In some aspects, the method 500 provides additional detail for the workflow 300 of FIG. 3.

At block 505, the machine learning system receives a set of tokens (e.g., the tokens 135 of FIG. 1 and/or the tokens 210 of FIGS. 2-3) from a secondary generative model (e.g., the secondary model 125 of FIGS. 1-2).

At block 510, the machine learning system identifies a subset of tokens, from the set of tokens, for verification. That is, the machine learning system identifies which subset of tokens were indicated (e.g., by a qualifier model) for verification by the primary model.

At block 515, the machine learning system generates a first set of hidden tensors (e.g., the hidden tensors 320A-N of FIG. 3) by processing the set of tokens using a first set of layers (e.g., the self-attention layers 315 of FIG. 3) of the primary machine learning model.

At block 520, the machine learning system generates a second set of hidden tensors (e.g., the hidden tensors 330 of FIG. 3) by processing a subset of the first set of hidden tensors (e.g., the hidden tensors corresponding to the indicated subset of tokens to be verified) using a second set of layers (e.g., the cross-attention layers 325 of FIG. 3) of the primary model.

At block 525, the machine learning system generates a set of target logits (e.g., the logits 340 of FIG. 3) for each token in the subset of to-be-verified tokens based on the second set of hidden tensors (e.g., using the linear layer 335 of FIG. 3).

At block 530, the machine learning system verifies (or attempts to verify) each token of the subset of to-be-verified tokens based on the target logits. In some aspects, as discussed above, the machine learning system verifies (or attempts to verify) each token based on comparing the token's target logits with the corresponding set of logits generated by the secondary machine learning model (e.g., the logits 215 of FIGS. 2-3).

At block 535, the machine learning system sends or returns a set of verified tokens (e.g., tokens marked for verification that were then verified by the primary model, and/or tokens generated by the secondary model and not marked for verification). For example, the machine learning system may transmit the verified tokens 155 of FIG. 1.

At block 540, the machine learning system optionally sends or returns a set of alternative token(s) for any tokens that were rejected by the primary model, as discussed above. For example, the machine learning system may process the corresponding target logits to generate a replacement or alternative token, and may provide this alternative token for inclusion in the model output.

As discussed above, this hybrid speculative decoding process can substantially reduce the latency and computational expense of generating the model output, as compared to some conventional approaches.

### Example Method for Generating Machine Learning Model Output Using a Secondary Generative Model

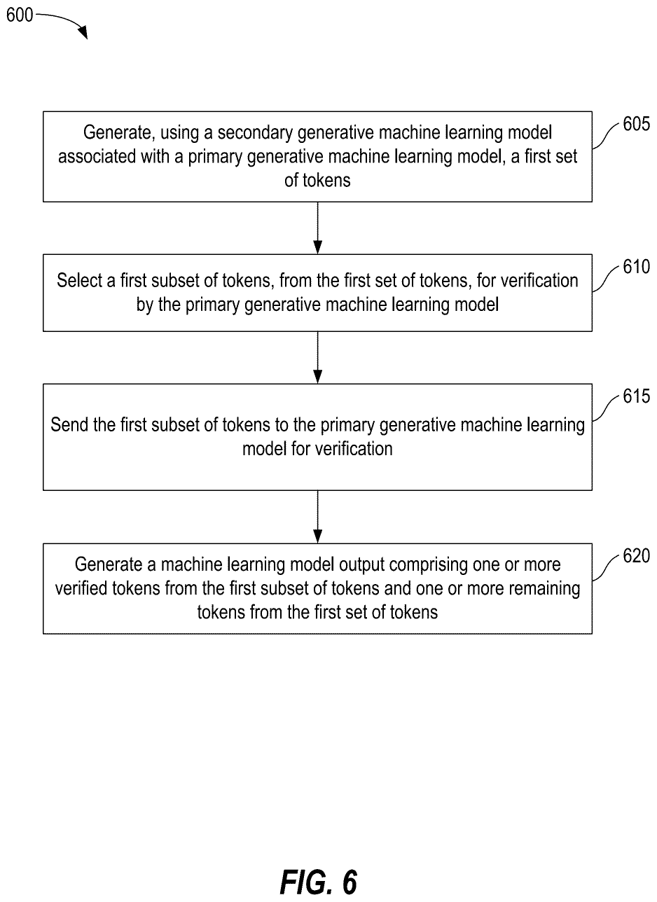

FIG. 6 is a flow diagram depicting an example method 600 for generating machine learning model output using a secondary generative model, according to some aspects of the present disclosure. In some aspects, the method 600 is performed by a machine learning system, such as the machine learning systems 110 and/or 115 of FIG. 1, and/or by one or more of the machine learning systems discussed above with reference to FIGS. 2-5.

At block 605, a first set of tokens (e.g., the tokens 135 of FIG. 1 and/or the tokens 210 of FIGS. 2-3) is generated using a secondary generative machine learning model (e.g., the secondary model 125 of FIGS. 1-2) associated with a primary generative machine learning model (e.g., the primary model 145 of FIG. 1).

At block 610, a first subset of tokens, from the first set of tokens, is selected for verification by the primary generative machine learning model.

At block 615, the first subset of tokens is sent to the primary generative machine learning model for verification.

At block 620, a machine learning model output (e.g., the output 120 of FIG. 1) comprising one or more verified tokens (e.g., the verified tokens 155 of FIG. 1) from the first subset of tokens and one or more remaining tokens from the first set of tokens is generated.

In some aspects, selecting the first subset of tokens comprises processing the first set of tokens using a qualifier machine learning model (e.g., the qualifier model 130 of FIGS. 1-2) to generate, for each respective token of the first set of tokens, a respective quality score, and selecting the first subset of tokens based on the respective quality scores.

In some aspects, generating the first set of tokens comprises iteratively generating tokens in the first set of tokens until the first set of tokens contains a defined maximum number of draft tokens.

In some aspects, generating the first set of tokens comprises iteratively generating and evaluating tokens in the first set of tokens until the first subset of tokens contains a defined number of tokens for verification.

In some aspects, the method 600 further includes generating, at the secondary generative machine learning model, a first set of logits (e.g., the selected logits 140 of FIG. 1 and/or the logits 215 of FIGS. 2-3) corresponding to the first subset of tokens, and sending, to the primary generative machine learning model, the first set of logits.

In some aspects, the method 600 further includes receiving the one or more verified tokens from the primary generative machine learning model, and receiving one or more alternative tokens from the primary generative machine learning model, wherein the machine learning model output further comprises the one or more alternative tokens.

In some aspects, the secondary generative machine learning model is executed using a first processing unit of a computing device (e.g., a CPU) and the primary generative machine learning model is executed using a second processing unit of the computing device (e.g., a GPU or NPU).

### Example Method for Verifying Machine Learning Model Output Using a Primary Generative Model

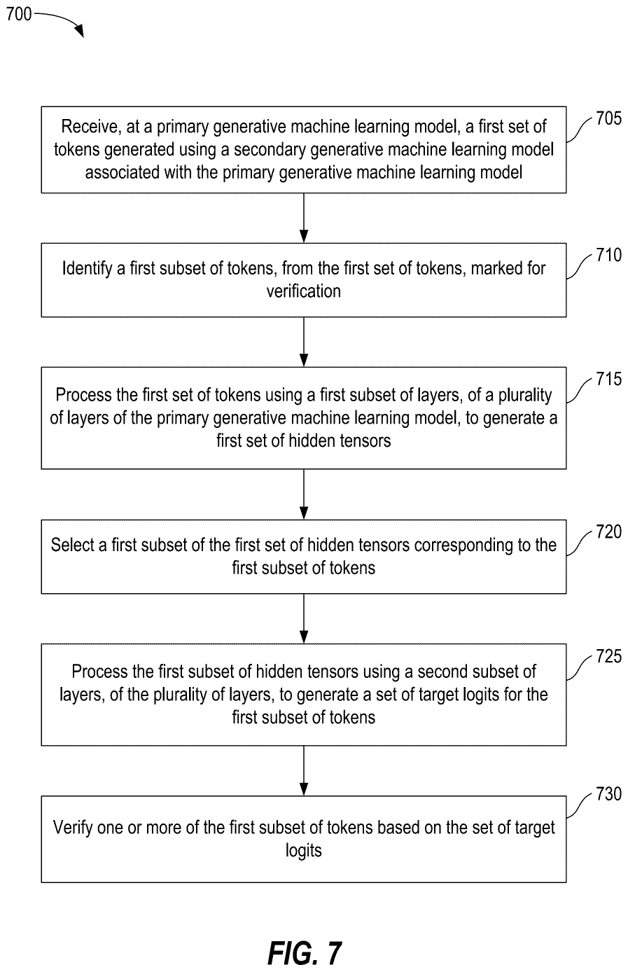

FIG. 7 is a flow diagram depicting an example method 700 for verifying machine learning model output using a primary generative model, according to some aspects of the present disclosure. In some aspects, the method 700 is performed by a machine learning system, such as the machine learning systems 110 and/or 115 of FIG. 1, and/or by one or more of the machine learning systems discussed above with reference to FIGS. 2-6.

At block 705, a first set of tokens (e.g., the tokens 135 of FIG. 1 and/or the tokens 210 of FIGS. 2-3) generated using a secondary generative machine learning model (e.g., the secondary model 125 of FIGS. 1-2) associated with a primary generative machine learning model (e.g., the primary model 145 of FIG. 1) is received at the primary generative machine learning model.

At block 710, a first subset of tokens is identified, from the first set of tokens, marked for verification.

At block 715, the first set of tokens is processed using a first subset of layers (e.g., the self-attention layers 315 of FIG. 3), of a plurality of layers of the primary generative machine learning model, to generate a first set of hidden tensors (e.g., the hidden tensors 320 of FIG. 3).

At block 720, a first subset of the first set of hidden tensors (e.g., the hidden tensor 320A and 320C of FIG. 3), corresponding to the first subset of tokens, is selected.

At block 725, the first subset of hidden tensors is processed using a second subset of layers (e.g., the cross-attention layers 325 of FIG. 3), of the plurality of layers, to generate a set of target logits (e.g., the logits 340 of FIG. 3) for the first subset of tokens.

At block 730, one or more of the first subset of tokens are verified based on the set of target logits.

In some aspects, processing the first subset of hidden tensors to generate the set of target logits for the first subset of tokens comprises generating a second subset of hidden tensors (e.g., the hidden tensors 330 of FIG. 3) using the second subset of layers, the second subset of hidden tensors corresponding to the first subset of tokens, and generating the set of target logits based on the second subset of hidden tensors and one or more remaining hidden tensors of the first subset of hidden tensors.

In some aspects, at least one layer of the first subset of layers comprises a self-attention operation (e.g., the self-attention layers 315 of FIG. 3).

In some aspects, at least one layer of the second subset of layers comprises a cross-attention operation (e.g., the cross-attention layers 325 of FIG. 3).

In some aspects, the method 700 further includes sending the one or more verified tokens (e.g., the verified tokens 155 of FIG. 1) to the secondary generative machine learning model.

In some aspects, the method 700 further includes receiving, at the primary generative machine learning model, a first set of logits (e.g., the selected logits 140 of FIG. 1 and/or the logits 215 of FIGS. 2-3) generated by the secondary generative machine learning model and corresponding to the first subset of tokens, and verifying the one or more of the first subset of tokens based on comparing the set of target logits to the first set of logits.

### Example Processing System for Machine Learning

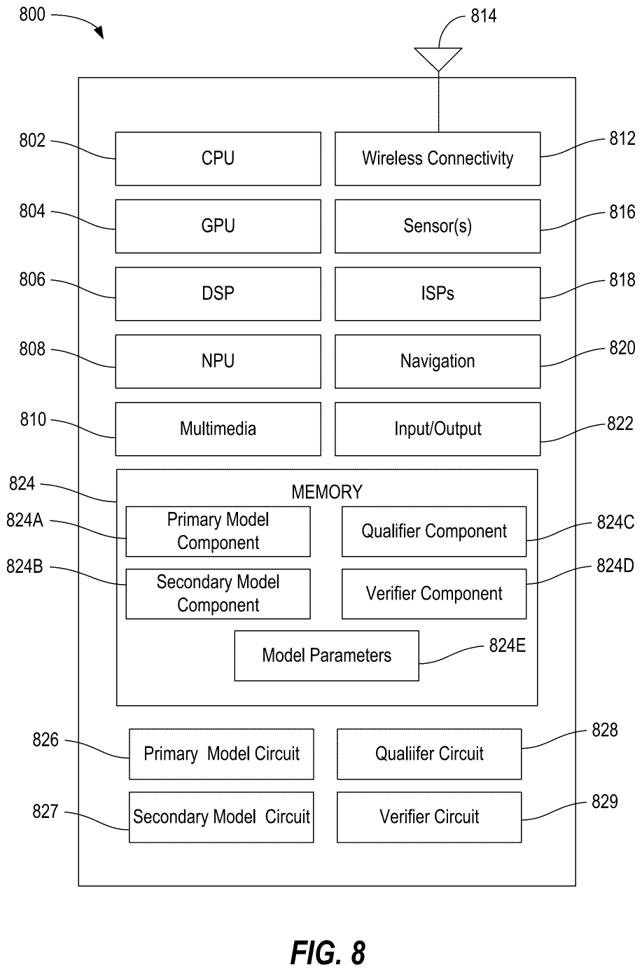

FIG. 8 depicts an example processing system 800 configured to perform various aspects of the present disclosure, including, for example, the techniques and methods described with respect to FIGS. 1-7. In some aspects, the processing system 800 may correspond to one or more machine learning systems. For example, the processing system 800 may correspond to the machine learning system 110 and/or the machine learning system 115, each of FIG. 1, and/or the machine learning systems discussed above with reference to FIGS. 2-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a primary model component 824A, a secondary model component 824B, a qualifier component 824C, and a verifier component 824D. Although not depicted in the illustrated example, the memory 824 may also include other components, such as an inferencing or generation component to manage the generation of output data using generative machine learning models, a training component used to train or update the generative machine learning model(s), and the like. Though depicted as discrete components for conceptual clarity in FIG. 8, the illustrated components (and others not depicted) may be collectively or individually implemented in various aspects.

Further, as illustrated, the memory 824 may also include various data, such as a set of model parameters 824E (e.g., parameters of one or more machine learning models), training data, and the like.

The processing system 800 further comprises a primary model circuit 826, a secondary model circuit 827, a qualifier circuit 828, and a verifier circuit 829. The depicted circuits, and others not depicted (such as an inferencing circuit), may be configured to perform various aspects of the techniques described herein.

The primary model component 824A and/or the primary model circuit 826 (which may correspond to the primary model 145 of FIGS. 1 and/or 3) may correspond to or use primary generative machine earning models to generate output and/or verify draft tokens, as discussed above. For example, the primary model component 824A and/or the primary model circuit 826 may use the primary model to verify the output of a secondary model.

The secondary model component 824B and/or the secondary model circuit 827 (which may correspond to the secondary model 125 of FIGS. 1 and/or 2) may be used to generate draft model output (e.g., tokens), as discussed above. For example, the secondary model component 824B and/or the secondary model circuit 827 may generate draft tokens where some of the tokens may be marked for verification and others may be automatically accepted for the final model output.

The qualifier component 824C and/or the qualifier circuit 828 (which may correspond to the qualifier model 130 of FIGS. 1 and/or 2) may be used to generate quality scores for draft tokens generated by the secondary model, as discussed above. For example, the qualifier component 824C and/or the qualifier circuit 828 may comprise a linear layer that predicts token quality and determines whether to mark a given token for verification by the primary model.

The verifier component 824D and/or the verifier circuit 829 (which may correspond to the verifier 150 of FIGS. 1 and/or 3) may be used to verify (or attempt to verify) draft tokens based on generated target logits, as discussed above. For example, the verifier component 824D and/or the verifier circuit 829 may compare target logits (generated using the primary model) with the corresponding logits generated by the secondary model in order to determine whether to verify each given token.

Though depicted as separate components and circuits for clarity in FIG. 8, the primary model circuit 826, the secondary model circuit 827, the qualifier circuit 828, and the verifier circuit 829 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, elements of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, elements of the processing system 800 may be distributed between multiple devices.

### Example Clauses

Implementation examples are described in the following numbered clauses:

Clause 1: A method, comprising: generating, using a secondary generative machine learning model associated with a primary generative machine learning model, a first set of tokens; selecting a first subset of tokens, from the first set of tokens, for verification by the primary generative machine learning model; sending the first subset of tokens to the primary generative machine learning model for verification; and generating a machine learning model output comprising one or more verified tokens from the first subset of tokens and one or more remaining tokens from the first set of tokens.

Clause 2: A method according to Clause 1, wherein selecting the first subset of tokens comprises: processing the first set of tokens using a qualifier machine learning model to generate, for each respective token of the first set of tokens, a respective quality score; and selecting the first subset of tokens based on the respective quality scores.

Clause 3: A method according to any of Clauses 1-2, wherein generating the first set of tokens comprises iteratively generating tokens in the first set of tokens until the first set of tokens contains a defined maximum number of draft tokens.

Clause 4: A method according to any of Clauses 1-3, wherein generating the first set of tokens comprises iteratively generating and qualifying tokens in the first set of tokens until the first subset of tokens contains a defined number of tokens for verification.

Clause 5: A method according to any of Clauses 1-4, further comprising: generating, at the secondary generative machine learning model, a first set of logits corresponding to the first subset of tokens; and sending, to the primary generative machine learning model, the first set of logits.

Clause 6: A method according to any of Clauses 1-5, further comprising: receiving the one or more verified tokens from the primary generative machine learning model; and receiving one or more alternative tokens from the primary generative machine learning model, wherein the machine learning model output further comprises the one or more alternative tokens.

Clause 7: A method according to any of Clauses 1-6, wherein: the secondary generative machine learning model is executed using a first processing unit of a computing device; and the primary generative machine learning model is executed using a second processing unit of the computing device.

Clause 8: A method according to any of Clauses 1-6, wherein: the secondary generative machine learning model is executed using a computing device; and the primary generative machine learning model is executed using a second computing device.

Clause 9: A method, comprising: receiving, at a primary generative machine learning model, a first set of tokens generated using a secondary generative machine learning model associated with the primary generative machine learning model; identifying a first subset of tokens, from the first set of tokens, marked for verification; processing the first set of tokens using a first subset of layers, of a plurality of layers of the primary generative machine learning model, to generate a first set of hidden tensors; selecting a first subset of the first set of hidden tensors corresponding to the first subset of tokens; processing the first subset of hidden tensors using a second subset of layers, of the plurality of layers, to generate a set of target logits for the first subset of tokens; and verifying one or more of the first subset of tokens based on the set of target logits.

Clause 10: A method according to Clause 9, wherein identifying the first subset of tokens comprises: processing the first set of hidden tensors using a qualifier machine learning model to generate, for each respective token of the first set of tokens, a respective quality score; and select the first subset of tokens based on the respective quality scores.

Clause 11: A method according to Clause 9, wherein processing the first subset of hidden tensors to generate the set of target logits for the first subset of tokens comprises: generating a second subset of hidden tensors using the second subset of layers, the second subset of hidden tensors corresponding to the first subset of tokens; and generating the set of target logits based on the second subset of hidden tensors and one or more remaining hidden tensors of the first subset of hidden tensors.

Clause 12: A method according to any of Clauses 9-11, wherein at least one layer of the first subset of layers comprises a self-attention operation.

Clause 13: A method according to any of Clauses 9-12, wherein at least one layer of the second subset of layers comprises a cross-attention operation.

Clause 14: A method according to any of Clauses 9-13, further comprising sending the one or more verified tokens to the secondary generative machine learning model.

Clause 15: A method according to any of Clauses 9-14, further comprising receiving, at the primary generative machine learning model, a first set of logits generated by the secondary generative machine learning model and corresponding to the first subset of tokens; and verifying the one or more of the first subset of tokens based on comparing the set of target logits to the first set of logits.

Clause 16: A processing system comprising: one or more memories comprising processor-executable instructions; and one or more processors coupled to the one or more memories and configured to execute the processor-executable instructions and cause the processing system to perform a method in accordance with any of Clauses 1-15.

Clause 17: A processing system comprising means for performing a method in accordance with any of Clauses 1-15.

Clause 18: A non-transitory computer-readable medium comprising computer-executable instructions that, when executed by one or more processors of a processing system, cause the processing system to perform a method in accordance with any of Clauses 1-15.

Clause 19: A computer program product embodied on a computer-readable storage medium comprising code for performing a method in accordance with any of Clauses 1-15.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
one or more memories comprising processor-executable instructions; and
one or more processors coupled to the one or more memories and configured to execute the processor-executable instructions and cause the processing system to:
generate, using a secondary generative machine learning model associated with a primary generative machine learning model, a first set of tokens;
select a first subset of tokens, from the first set of tokens, for verification by the primary generative machine learning model;
send the first subset of tokens to the primary generative machine learning model for verification; and
generate a machine learning model output comprising one or more verified tokens from the first subset of tokens and one or more remaining tokens from the first set of tokens.

2. The processing system of claim 1, wherein, to select the first subset of tokens, the one or more processors are configured to execute the processor-executable instructions and cause the processing system to:
process the first set of tokens using a qualifier machine learning model to generate, for each respective token of the first set of tokens, a respective quality score; and
select the first subset of tokens based on the respective quality scores.

3. The processing system of claim 1, wherein, to generate the first set of tokens, the one or more processors are configured to execute the processor-executable instructions and cause the processing system to iteratively generate tokens in the first set of tokens until the first set of tokens contains a defined maximum number of draft tokens.

4. The processing system of claim 1, wherein, to generate the first set of tokens, the one or more processors are configured to execute the processor-executable instructions and cause the processing system to iteratively generate and qualify tokens in the first set of tokens until the first subset of tokens contains a defined number of tokens for verification.

5. The processing system of claim 1, wherein the one or more processors are further configured to execute the processor-executable instructions and cause the processing system to:
generate, at the secondary generative machine learning model, a first set of logits corresponding to the first subset of tokens; and
send, to the primary generative machine learning model, the first set of logits.

6. The processing system of claim 1, wherein the one or more processors are further configured to execute the processor-executable instructions and cause the processing system to:
receive the one or more verified tokens from the primary generative machine learning model; and
receive one or more alternative tokens from the primary generative machine learning model, wherein the machine learning model output further comprises the one or more alternative tokens.

7. The processing system of claim 1, wherein:
the secondary generative machine learning model is executed using a first processing unit of a computing device; and
the primary generative machine learning model is executed using a second processing unit of the computing device.

8. The processing system of claim 1, wherein:
the secondary generative machine learning model is executed using a computing device; and
the primary generative machine learning model is executed using a second computing device.

9. A processing system for machine learning, comprising:
one or more memories comprising processor-executable instructions; and
one or more processors coupled to the one or more memories and configured to execute the processor-executable instructions and cause the processing system to:
receive, at a primary generative machine learning model, a first set of tokens generated using a secondary generative machine learning model associated with the primary generative machine learning model;
identify a first subset of tokens, from the first set of tokens, marked for verification;
process the first set of tokens using a first subset of layers, of a plurality of layers of the primary generative machine learning model, to generate a first set of hidden tensors;
select a first subset of the first set of hidden tensors corresponding to the first subset of tokens;
process the first subset of hidden tensors using a second subset of layers, of the plurality of layers, to generate a set of target logits for the first subset of tokens; and
verify one or more tokens in the first subset of tokens based on the set of target logits.

10. The processing system of claim 9, wherein, to identify the first subset of tokens, the one or more processors are configured to execute the processor-executable instructions and cause the processing system to:
process the first set of hidden tensors using a qualifier machine learning model to generate, for each respective token of the first set of tokens, a respective quality score; and
select the first subset of tokens based on the respective quality scores.

11. The processing system of claim 9, wherein, to process the first subset of hidden tensors to generate the set of target logits for the first subset of tokens, the one or more processors are configured to execute the processor-executable instructions and cause the processing system to:
generate a second subset of hidden tensors using the second subset of layers, the second subset of hidden tensors corresponding to the first subset of tokens; and
generate the set of target logits based on the second subset of hidden tensors and one or more remaining hidden tensors of the first subset of hidden tensors.

12. The processing system of claim 9, wherein at least one layer of the first subset of layers comprises a self-attention operation.

13. The processing system of claim 9, wherein at least one layer of the second subset of layers comprises a cross-attention operation.

14. The processing system of claim 9, wherein the one or more processors are further configured to execute the processor-executable instructions and cause the processing system to send the one or more verified tokens to the secondary generative machine learning model.

15. The processing system of claim 9, wherein the one or more processors are further configured to execute the processor-executable instructions and cause the processing system to:
receive, at the primary generative machine learning model, a first set of logits generated by the secondary generative machine learning model and corresponding to the first subset of tokens; and
verify the one or more of the first subset of tokens based on comparing the set of target logits to the first set of logits.

16. A processor-implemented method for machine learning, comprising:
generating, using a secondary generative machine learning model associated with a primary generative machine learning model, a first set of tokens;
selecting a first subset of tokens, from the first set of tokens, for verification by the primary generative machine learning model;
sending the first subset of tokens to the primary generative machine learning model for verification; and
generating a machine learning model output comprising one or more verified tokens from the first subset of tokens and one or more remaining tokens from the first set of tokens.

17. The method of claim 16, wherein selecting the first subset of tokens comprises:
processing the first set of tokens using a qualifier machine learning model to generate, for each respective token of the first set of tokens, a respective quality score; and
selecting the first subset of tokens based on the respective quality scores.

18. The method of claim 16, wherein generating the first set of tokens comprises iteratively generating tokens in the first set of tokens until the first set of tokens contains a defined maximum number of draft tokens.

19. The method of claim 16, wherein generating the first set of tokens comprises iteratively generating and evaluating tokens in the first set of tokens until the first subset of tokens contains a defined number of tokens for verification.

20. The method of claim 16, further comprising:
generating, at the secondary generative machine learning model, a first set of logits corresponding to the first subset of tokens; and
sending, to the primary generative machine learning model, the first set of logits.
